(19) United States
(12) Patent Application Publication
(10) Pub. No.: US 2026/0296421 A1
(43) Pub. Date: Oct. 1, 2026

(54) VEHICLE CONTROL DEVICE, VEHICLE CONTROL METHOD, AND PROGRAM

(71) Applicant: HONDA MOTOR CO., LTD., Tokyo (JP)

(72) Inventors: Yuki Kitamura, Tokyo (JP); Yuki Ichino, Tokyo (JP)

(21) Appl. No.: 19/550,089

(22) Filed: Feb. 25, 2026

(30) Foreign Application Priority Data
Mar. 26, 2025 (JP) 2025-051387

(51) Int. Cl. B60W 30/12

(52) U.S. Cl. CPC B60W 30/12; B60W 2520/12; B60W 2552/10; B60W 2552/30

(57) ABSTRACT

A vehicle control device includes: a recognition unit that recognizes a travel lane of a self-vehicle; and a control unit that performs a departure mitigation control of the self-vehicle when the recognition unit detects that the self-vehicle is likely to depart from the travel lane and determines whether or not it is possible to end the departure mitigation control, wherein the control unit performs a first departure mitigation control when the travel lane from which the self-vehicle is likely to depart is a straight road, performs a second departure mitigation control when the travel lane from which the self-vehicle is likely to depart is a curve, performs a determination by a first end condition which is an end condition of the first departure mitigation control and a second end condition which is an end condition of the second departure mitigation control, and sets the second end condition to be less likely to be established than the first end condition.

### CROSS-REFERENCE TO RELATED APPLICATION

Priority is claimed on Japanese Patent Application No. 2025-051387, filed on Mar. 26, 2025, the contents of which are incorporated herein by reference.

### BACKGROUND

### Field of the Invention

The present invention relates to a vehicle control device, a vehicle control method, and a program.

### Background

In recent years, there have been increasing attempts to provide access to a sustainable transportation system that takes vulnerable traffic participants into consideration. In order to realize this effort, research and development relating to preventive safety techniques have been focused on in order to improve road safety and convenience. For example, a device that gradually decreases a control amount at the end of a control that mitigates the road departure of a vehicle has been disclosed (for example, refer to Japanese Unexamined Patent Application, First Publication No. 2024-118722).

### SUMMARY

In the device of the related art, a condition of ending the control that mitigates the road departure of the vehicle has not been sufficiently studied.

An aspect of the present invention aims at providing a vehicle control device, a vehicle control method, and a program that can appropriately end a mitigation control of road departure. As described above, the aspect of the present invention improves preventive safety techniques and eventually contributes to development of sustainable transportation systems.

A vehicle control device according to a first aspect of the present invention includes: a recognition unit that recognizes a travel lane of a self-vehicle; and a control unit that performs a departure mitigation control of the self-vehicle when the recognition unit detects that the self-vehicle is likely to depart from the travel lane and determines whether or not it is possible to end the departure mitigation control, wherein the control unit performs a first departure mitigation control when the travel lane from which the self-vehicle is likely to depart is a straight road, performs a second departure mitigation control when the travel lane from which the self-vehicle is likely to depart is a curve, performs a determination by a first end condition which is an end condition of the first departure mitigation control and a second end condition which is an end condition of the second departure mitigation control, and sets the second end condition to be less likely to be established than the first end condition.

A second aspect is the vehicle control device according to the first aspect described above, wherein the end conditions of the first departure mitigation control and the second departure mitigation control may be an elapsed time in which the self-vehicle becomes a stable state in a travel lane, and the second end condition may be set to be longer than the first end condition.

A third aspect is the vehicle control device according to the second aspect described above, wherein the stable state may be a state in which the self-vehicle is present within a predetermined range from a travel lane center.

A fourth aspect is the vehicle control device according to the second aspect described above, wherein the stable state may be a state in which a lateral speed of the self-vehicle is within a threshold value.

A fifth aspect is the vehicle control device according to the second aspect described above, wherein the stable state may be a state in which the self-vehicle is present within a predetermined range from a travel lane center and be a state in which the lateral speed of the self-vehicle is within a threshold value.

A vehicle control method according to a sixth aspect of the present invention includes: by way of a computer, recognizing a travel lane of a self-vehicle; performing, when it is detected that the self-vehicle is likely to depart from the travel lane, a first departure mitigation control when the travel lane from which the self-vehicle is likely to depart is a straight road; performing a second departure mitigation control when the travel lane from which the self-vehicle is likely to depart is a curve; determining whether or not it is possible to end the departure mitigation control by a first end condition which is an end condition of the first departure mitigation control and a second end condition which is an end condition of the second departure mitigation control; and setting the second end condition to be less likely to be established than the first end condition.

A seventh aspect of the present invention is a computer-readable non-transitory storage medium storing a program that causes a computer to: recognize a travel lane of a self-vehicle; perform, when it is detected that the self-vehicle is likely to depart from the travel lane, a first departure mitigation control when the travel lane from which the self-vehicle is likely to depart is a straight road; perform a second departure mitigation control when the travel lane from which the self-vehicle is likely to depart is a curve; determine whether or not it is possible to end the departure mitigation control by a first end condition which is an end condition of the first departure mitigation control and a second end condition which is an end condition of the second departure mitigation control; and set the second end condition to be less likely to be established than the first end condition.

According to the first to seventh aspects, it becomes possible to appropriately end a mitigation control of road departure. In particular, by setting the second end condition to be less likely to be established than the first end condition, it is possible to prevent the second departure mitigation control from being unintentionally ended.

### BRIEF DESCRIPTION OF THE DRAWINGS

FIG. 1 is a configuration view of a vehicle system using a vehicle control device according to an embodiment.

FIG. 2 is a view showing a control executed by a first departure control unit.

FIG. 3 is a view showing a control executed by a second departure control unit.

FIG. 4 is a flowchart showing an example of a flow of determination of whether or not it is possible to end a departure mitigation control.

FIG. 5 is a view showing a relationship between a vehicle head center of a vehicle and a lane center.

FIG. 6 is a view showing the case where the vehicle enters a curve on an inside relative to the curve.

FIG. 7 is a flowchart showing another example of a flow of determination of whether or not it is possible to end a departure mitigation control.

### DESCRIPTION OF EMBODIMENTS

### Embodiment

### Overall Configuration

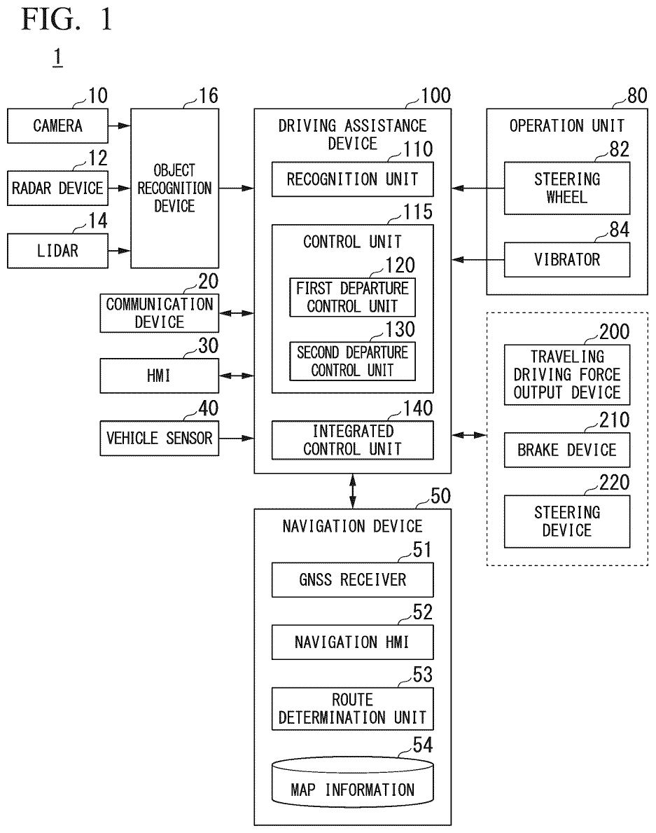

FIG. 1 is a configuration view of a vehicle system 1 using a vehicle control device according to an embodiment. A vehicle on which the vehicle system 1 is mounted is, for example, a two-wheeled, three-wheeled or four-wheeled vehicle, and a drive source thereof is an internal combustion engine such as a diesel engine or a gasoline engine, an electric motor, or a combination thereof. The electric motor is operated by using electric power generated by a generator connected to an internal combustion engine or electric power discharged from a secondary battery or a fuel cell.

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an operation unit 80, a driving assistance device 100, a traveling driving force output device 200, a brake device 210, and a steering device 220. These devices and equipment are connected to each other by a multiple communication line such as a CAN (Controller Area Network) communication line, a serial communication line, a wireless communication network, or the like. The configuration shown in FIG. 1 is merely an example, and part of the configuration may be omitted, or another configuration may be added. The driving assistance device 100 is an example of a “vehicle control device.”

The camera 10 is, for example, a digital camera using a solid-state imaging element such as a CCD (Charge Coupled Device) or a CMOS (Complementary Metal Oxide Semiconductor). The camera 10 is attached to an arbitrary portion of a vehicle (hereinafter, a vehicle M) on which the vehicle system 1 is mounted. When capturing an image in a forward direction, the camera 10 is attached to a front windshield upper portion, a rearview mirror back surface, or the like. For example, the camera 10 repeatedly captures an image around the vehicle M periodically. The camera 10 may be a stereo camera.

The radar device 12 emits radio waves such as millimeter waves to the surroundings of the vehicle M and detects radio waves (reflected waves) reflected by an object to detect at least a position (distance and azimuth) of the object. The radar device 12 is attached to an arbitrary portion of the vehicle M. The radar device 12 may detect the position and the speed of the object by a FM-CW (Frequency Modulated Continuous Wave) method.

The LIDAR 14 emits light (or electromagnetic waves having a wavelength close to light) to the surroundings of the vehicle M and measures scattered light. The LIDAR 14 detects the distance to a target on the basis of a time from light emission to light reception. The emitted light is, for example, a pulsed laser beam. The LIDAR 14 is attached to an arbitrary portion of the vehicle M.

The object recognition device 16 performs a sensor fusion process on a detection result by part or all of the camera 10, the radar device 12, and the LIDAR 14 and recognizes the position, the type, the speed, or the like, of the object. The object recognition device 16 outputs a recognition result to the driving assistance device 100. The object recognition device 16 may output the detection result of the camera 10, the radar device 12, and the LIDAR 14 to the driving assistance device 100 as it is. The object recognition device 16 may be omitted from a vehicle system 1.

The communication device 20 communicates with another vehicle that is present around the vehicle M, for example, by using a cellular network, a Wi-Fi network, Bluetooth (Registered trademark), DSRC (Dedicated Short-Range Communication), or the like or communicates with various server devices via a wireless base station.

The HMI 30 presents various information to an occupant of the vehicle M and accepts an input operation by the occupant. The HMI 30 includes, various display devices, a speaker, a buzzer, a touch panel, a switch, a key, and the like. The HMI 30 includes a display device. The display device (display portion) is, for example, a display device that displays various information in the vehicle M, that is a multi-information display, such as a speedometer indicating a travel speed of the vehicle M or a tachometer indicating a rotation speed of the internal combustion engine included in the vehicle M, the speed meter and the tachometer being provided on a center portion of an instrument panel of the vehicle M.

The vehicle sensor 40 includes a vehicle speed sensor that detects the speed of the vehicle M, an acceleration sensor that detects acceleration, a yaw rate sensor that detects the angular speed around a vertical axis, an azimuth sensor that detects the orientation of the vehicle M, and the like.

The navigation device 50 includes, for example, a GNSS (Global Navigation Satellite System) receiver 51, a navigation HMI 52, and a route determination unit 53. The navigation device 50 stores map information 54 in a storage device such as an HDD (Hard Disk Drive) or a flash memory. The GNSS receiver 51 specifies a position of the vehicle M on the basis of a signal received from a GNSS satellite. The position of the vehicle M may be specified or supplemented by an INS (Inertial Navigation System) using an output of the vehicle sensor 40. The navigation HMI 52 includes a display device, a speaker, a touch panel, a key, and the like. The navigation HMI 52 may be partially or wholly shared with the HMI 30 described above. For example, the route determination unit 53 determines a route (hereinafter, a route on a map) to a destination input by the occupant by using the navigation HMI 52 from the position (or an arbitrary position that is input) of the vehicle M specified by the GNSS receiver 51 with reference to the map information 54. The map information 54 is, for example, information in which a road shape is expressed by a link indicating a road and nodes connected by the link. The map information 54 may include a road curvature, POI (Point of Interest) information, and the like. The map information 54 includes, for example, information indicating a specified speed (for example, a speed limit or a legal speed) for each link indicating a road. The specified speed is information indicating, for example, the speed limit and the legal speed displayed on a road, a signboard provided on a road, or the like.

The navigation device 50 may perform route guidance using the navigation HMI 52 on the basis of the route on a map. The navigation device 50 may be realized by, for example, a function of a terminal device such as a smartphone or a tablet terminal held by the occupant. The navigation device 50 may transmit the current position and the destination to a navigation server via the communication device 20 and acquire a route similar to the route on a map from the navigation server.

The operation unit 80 includes, for example, an operation switch of a direction indicator, an accelerator pedal, a brake pedal, a shift lever, and other operation elements (not shown). A sensor that detects an amount of operation or the presence or absence of operation is attached to an operation element, and the detection result is output to the driving assistance device 100 or part or all of the traveling driving force output device 200, the brake device 210, and the steering device 220. The steering wheel does not necessarily have an annular shape and may have a shape of an odd-shaped steering wheel, a joystick, a button, or the like. A steering grip sensor is attached to the steering wheel.

In addition to the above, the operation unit 80 includes a steering wheel 82 and a vibrator 84.

The vibrator 84 vibrates the steering wheel 82. For example, the vibrator 84 vibrates based on a command of the driving assistance device 100 and notifies the driver that the vehicle M is approaching a road lane line, that the vehicle M has reached a road lane line, or that the vehicle M has deviated from a road lane line.

The driving assistance device 100 includes, for example, a recognition unit 110, a control unit 115, and an integrated control unit 140. Further, the control unit 115 includes a first departure control unit 120 and a second departure control unit 130. Some or all of these function units are realized by, for example, a hardware processor such as a CPU (Central Processing Unit) executing a program (software). Some or all of these components may be realized by hardware (a circuit unit; including circuitry) such as an LSI (Large Scale Integration), an ASIC (Application Specific Integrated Circuit), an FPGA (Field-Programmable Gate Array), a GPU (Graphics Processing Unit), or an SOC (System on Chip) or may be realized by software and hardware in cooperation. A program may be stored in advance in a storage device (a storage device including a non-transitory storage medium) such as an HDD or a flash memory of the driving assistance device 100, or may be stored in a detachable storage medium such as a DVD or a CD-ROM and be installed in the HDD or the flash memory of the driving assistance device 100 by the storage medium (non-transitory storage medium) being attached to a drive device.

The recognition unit 110 recognizes states such as the position, the speed, and the acceleration of an object that is present around the vehicle M on the basis of information input from the camera 10, the radar device 12, and the LIDAR 14 via the object recognition device 16. The position of the object is recognized, for example, as a position on absolute coordinates using a representative point (a center of gravity, a drive shaft center, or the like) of the vehicle M as an origin and is used in a control. The position of the object may be expressed by a representative point such as the center of gravity or a corner of the object or may be expressed by an area.

The “state” of the object may include the acceleration or jerk of the object, or a “behavior state” (for example, whether or not a lane is being changed or is about to be changed).

For example, the recognition unit 110 recognizes a road lane line around the vehicle M and recognizes a travel lane on the basis of the recognized road lane line. The recognition unit 110 may recognize a travel lane by recognizing a travel road boundary (road boundary), which are not limited to the road lane line but include a road lane line, a road shoulder, a curb, a median strip, a guard rail, and the like. In this recognition, the position of the vehicle M acquired from the navigation device 50 and a process result by the INS may be taken into consideration. The recognition unit 110 recognizes a temporary stop line, an obstacle, red traffic light, a toll gate, other road events, a mark (a speed limit) marked on a road, and a road sign on which the speed limit is marked.

The recognition unit 110 recognizes the position and a posture of the vehicle M with respect to a travel lane when the travel lane is recognized. The recognition unit 110 may recognize, for example, a deviation of a reference point of the vehicle M from a center of a lane and an angle formed with respect to a line connecting the center of the lane in the traveling direction of the vehicle M as a relative position and a posture of the vehicle M with respect to the travel lane. Alternatively, the recognition unit 110 may recognize the position or the like of the reference point of the vehicle M with respect to any side end (a road lane line or a road boundary) of the travel lane as the relative position of the vehicle M with respect to the travel lane.

When it is detected by the recognition unit 110 that the vehicle M is likely to depart from the travel lane, the control unit 115 performs a departure mitigation control of the vehicle M by the first departure control unit 120 or the second departure control unit 130. Further, the control unit 115 determines whether or not it is possible to end the departure mitigation control by determining whether or not a predetermined condition is satisfied.

### First Departure Control Unit

The first departure control unit 120 prevents the vehicle M from departing from the road when the driver is controlling the vehicle M. The first departure control unit 120 implements a so-called road departure mitigation function (RDM; Road Departure Mitigation). The first departure control unit 120 executes a first departure mitigation control when the vehicle M is likely to change the lane or depart from a road lane line in a state where a direction indicator is not blinking. Examples of the first departure mitigation control include issuing a warning regarding departure from a road lane line, issuing a warning by vibration of the vibrator 84 of the steering wheel 82, providing steering assistance for causing the vehicle M to approach the center of the lane, and the like.

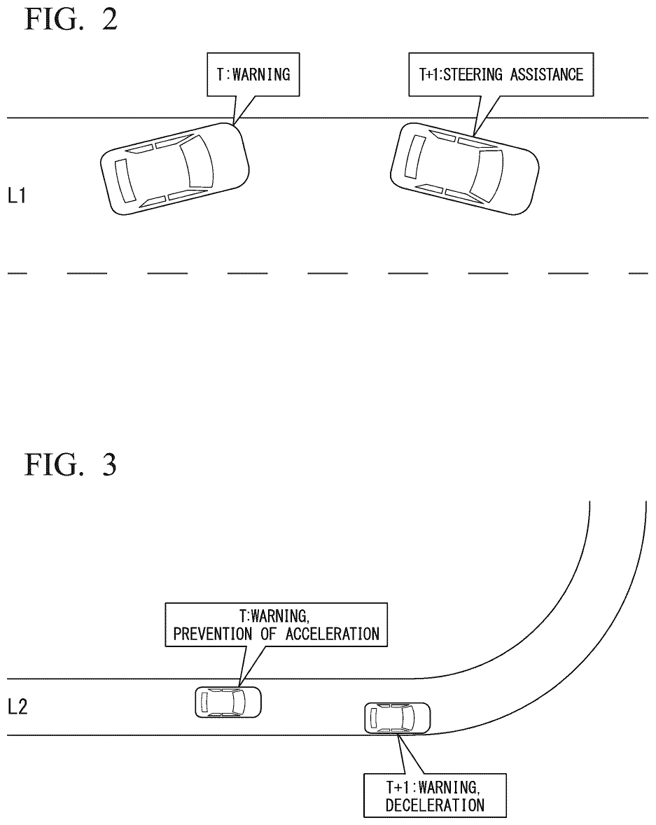

FIG. 2 is a view showing a control executed by the first departure control unit 120. When a condition of the first departure control is satisfied at a time T, the first departure control unit 120 outputs a warning by using the HMI 30. The condition of the first departure control is that the vehicle M reaches a position away from the center of a lane L1 by a predetermined distance or more, that the vehicle reaches a position away from a position of a road lane line of the lane L1 by a predetermined distance, or the like. When the vehicle M is closer to the road lane line at a time T+1 than the position of the vehicle M at the time T, the first departure control unit 120 strengthens the mitigation control further than that at the time T. Strengthening of the mitigation control is that a warning which is further recognized by a driver is issued, that steering assistance which controls the vehicle M to the center of the lane is performed, or the like.

By executing the first departure control as described above, the first departure control unit 120 can prevent the vehicle M from departing from the road.

### Second Departure Control Unit

The second departure control unit 130 prevents the vehicle M from departing from a curved road when the driver is controlling the vehicle M. The second departure control unit 130 implements a so-called curved road departure early warning. The second departure control unit 130 executes a second departure mitigation control in the case where the vehicle M is likely to depart from the curved road when the vehicle M approaches the entrance of the curved road. Examples of the second departure mitigation control include issuing a warning regarding departure from a road lane line of the curved road, issuing a warning by vibration of the vibrator 84 of the steering wheel 82, preventing acceleration of the vehicle M, decelerating the vehicle M, providing steering assistance for causing the vehicle M to approach the center of the lane, and the like.

Whether or not the vehicle is likely to depart is determined by taking part or all of the following target information into consideration. The target information includes, for example, the radius of curvature of the curved road, the degree of change in the curvature of the curved road, an arrival time, turning acceleration, and the like. The arrival time is, for example, an arrival time until the vehicle M reaches a road lane line, which is obtained based on the position of the road lane line with respect to the vehicle M and the state (for example, a position, a traveling direction, the speed, and an acceleration) of the vehicle M. The turning acceleration is, for example, a predicted acceleration to the vehicle M when the vehicle M turns a curved road. For example, when the radius of curvature of the curved road is equal to or less than a first threshold value, the degree of change in curvature is equal to or more than a second threshold value, the arrival time is equal to or less than a third threshold value, and the turning acceleration is equal to or more than a fourth threshold value, it is determined that the vehicle M is likely to depart from the curved road, and the second departure mitigation control is executed.

FIG. 3 is a view showing a control executed by the second departure control unit 130. For example, when the vehicle M travels in a lane L2 and reaches a position by a predetermined distance before the entrance of a curved road that is subject to the second departure mitigation control, and there is a risk that the vehicle M will depart from the curved road, the second departure control unit 130 issues a warning and prevents acceleration to prompt the driver to recognize the curved road. When the driver does not decelerate the vehicle M, the vehicle M travels, and the vehicle M further approaches a road lane line of the curved road, the second departure control unit 130 performs deceleration or performs steering assistance in addition to the issuing of a warning.

By executing the second departure control as described above, the second departure control unit 130 can prevent the vehicle M from departing from the curved road.

In addition to the first departure control and the second departure control described above, the driving assistance device 100 may execute an ACC (Adaptive Cruise Control), a lane keeping control for causing the vehicle M to travel in the center of the lane, or a control for performing an automatic lane change (ALC) that automatically causing the vehicle M to change the lane when a lane change is commanded by the driver.

The integrated control unit 140 controls, for example, each part of the vehicle M such as the communication device 20 or the HMI 30.

The traveling driving force output device 200 outputs a traveling driving force (torque) for the vehicle to travel to a drive wheel. The traveling driving force output device 200 includes, for example, a combination of an internal combustion engine, a motor, a transmission, and the like, and an ECU that controls these elements. The ECU controls the configuration described above in accordance with information input from the driving assistance device 100 or information input from a driving operator.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor in accordance with the information input from the driving assistance device 100 or the information input from the driving operator and outputs a brake torque in accordance with a braking operation to each wheel.

The steering device 220 includes, for example, a steering ECU and an electric motor.

The electric motor changes, for example, a direction of a steering wheel by applying a force to a rack and pinion mechanism. The steering ECU drives the electric motor in accordance with the information input from the driving assistance device 100 or the information input from the driving operator and changes the direction of the steering wheel.

### Outline

The recognition unit 110 of the driving assistance device 100 recognizes a travel lane of the vehicle M. When the recognition unit 110 detects that the vehicle M is likely to depart from the travel lane, the control unit 115 performs a departure mitigation control of the vehicle M and determines whether or not it is possible to end the departure mitigation control. Here, when the travel lane from which the vehicle M is likely to depart is a straight road, the control unit 115 performs a first departure mitigation control which is a straight road departure mitigation control by the first departure control unit 120. Further, when the travel lane from which the vehicle M is likely to depart is a curve, the control unit 115 performs a second departure mitigation control which is a curve departure mitigation control by the second departure control unit 130.

Here, the control unit 115 performs a determination by a first end condition which is an end condition of the first departure mitigation control and a second end condition which is an end condition of the second departure mitigation control. The second end condition is set to be less likely to be established than the first end condition.

Further, the end conditions of the first departure mitigation control and the second departure mitigation control are an elapsed time in which the vehicle M becomes a stable state in a travel lane, and the second end condition is set to be longer than the first end condition.

The “stable state” described above is:
1) a state in which the vehicle M is present within a predetermined range from a travel lane center; and/or
2) a state in which a lateral speed of the vehicle M is within a threshold value. Whether or not the vehicle is within a predetermined range from the travel lane center is determined based on, for example, a vehicle head center.

As the second end condition of the second departure mitigation control, by adding a condition that the vehicle M is in a state after returning from the departure from the travel lane of the vehicle M in the second departure mitigation control, the second end condition may be set to be less likely to be established than the first end condition.

### Determination Flow

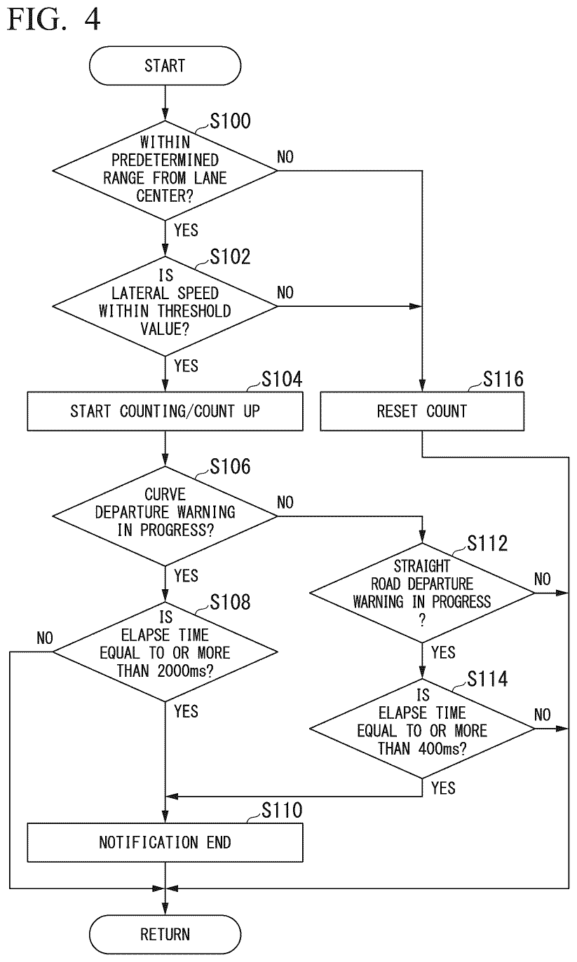

Next, an operation of determining whether or not it is possible to end the departure mitigation control by the control unit 115 of the driving assistance device 100 after the departure mitigation control of a self-vehicle is started is described. FIG. 4 is a flowchart showing an example of a flow of determination of whether or not it is possible to end the departure mitigation control executed by the control unit 115. The determination routine of FIG. 4 is called sequentially after the departure mitigation control by the first departure control unit 120 or the second departure control unit 130 of the control unit 115 is started until it is determined that the departure mitigation control is ended and performs a predetermined determination process.

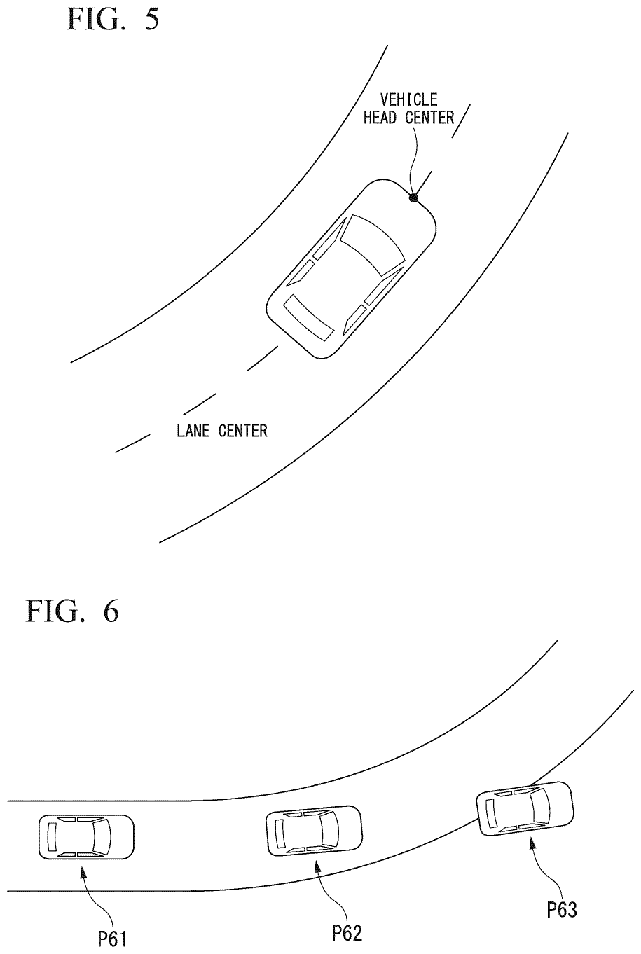

The control unit 115 determines whether the vehicle M is in a state in which the self-vehicle is present within a predetermined range from the travel lane center on the basis of information from the recognition unit 110 (Step S100). FIG. 5 is a view showing a relationship between a vehicle head center of the vehicle M and a lane center. In Step S100, the control unit 115 determines that the vehicle M is present within a predetermined range from the travel lane center, for example, when the vehicle head center of the vehicle M is present within ±20 cm from the travel lane center. The term “within a predetermined range from the travel lane center” is not limited to ±20 cm and may be a value with which it is possible to determine that the vehicle is not in a departure situation from the road based on a vehicle width, a road width, or the like. Further, it may be determined that the self-vehicle is present within the predetermined range from the travel lane center by determining whether the vehicle M is separated from a departure side lane line by a set distance (for example, 30 cm) to a lane return side instead of determining whether the vehicle M is in a state in which the self-vehicle is present within the predetermined range from the travel lane center. Thereby, even when only the departure side lane line can be seen, and the lane center cannot be calculated, it is possible to perform the determination.

When it is determined that the vehicle M is in a state in which the self-vehicle is present within the predetermined range from the travel lane center (Step S100: Yes), the control unit 115 determines whether the lateral speed of the vehicle M is within the threshold value based on information from the vehicle sensor 40 (Step S102). The “threshold value” of the lateral speed is, for example, 0.1 m/s. The “threshold value” of the lateral speed is not limited to 0.1 m/s and may be a value with which it is possible to determine that the vehicle M is traveling substantially straight or along a sufficiently mild curve.

When it is determined that the lateral speed of the vehicle M is within the threshold value (Step S102: Yes), the control unit 115 starts counting by a counter or counts up the counter (Step S104). Here, in the case of a first process shown in FIG. 4 from the start of the departure mitigation control, the counting by the counter is started. Further, in the case of a continued process shown in FIG. 4 other than the first process from the start of the departure mitigation control, the counting up of the counter is performed. The counter is used for measuring a duration time of the states of Steps S100 and S102. Further, the determination of Steps S100 and S102 by the control unit 115 is a determination of whether or not the vehicle M is traveling in a stable state in the travel lane. That is, the control unit 115 measures a travel time in the stable state in the travel lane of the vehicle M by the process of Step S104.

Subsequently, the control unit 115 determines whether a curve departure warning by the second departure control unit 130 is in progress (Step S106).

When it is determined that the curve departure warning is in progress (Step S106: Yes), the control unit 115 determines whether an elapsed time in which the vehicle M is traveling in the stable state in the travel lane becomes equal to or more than a predetermined time by referring to the counter value (Step S108). The “predetermined time” is, for example, 2000 ms.

When it is determined that the elapsed time in which the vehicle is traveling in the stable state is equal to or more than the predetermined time (Step S108: Yes), the control unit 115 determines that a notification process in the departure mitigation control is ended (Step S110). Further, the control unit 115 transfers the control to a process unit that has called the process of FIG. 4 with status information indicating that the notification in the departure mitigation control is ended.

When it is determined that the elapsed time in which the vehicle is traveling in the stable state is not equal to or more than the predetermined time (Step S108: No), the control unit 115 transfers the control to the process unit that has called the process of FIG. 4 in order to continue the end determination of the notification process in the departure mitigation control.

On the other hand, when it is determined that the curve departure warning is not in progress (Step S106: No), the control unit 115 determines whether a straight road departure warning by the first departure control unit 120 is in progress (Step S112).

When it is determined that the straight road departure warning is in progress (Step S112: Yes), the control unit 115 determines whether an elapsed time in which the vehicle M is traveling in the stable state in the travel lane becomes equal to or more than a predetermined time by referring to the counter value (Step S114). The “predetermined time” is, for example, 400 ms.

When it is determined that the elapsed time in which the vehicle is traveling in the stable state is equal to or more than the predetermined time (Step S114: Yes), the control unit 115 determines that a notification process in the departure mitigation control is ended (Step S114). Further, the control unit 115 transfers the control to the process unit that has called the process of FIG. 4 with status information indicating that the notification in the departure mitigation control is ended.

When it is determined that the straight road departure warning is not in progress (Step S112: No) or when it is determined that the elapsed time in which the vehicle is traveling in the stable state is not equal to or more than the predetermined time (Step S114: No), the control unit 115 transfers the control to the process unit that has called the process of FIG. 4 in order to continue the end determination of the notification process in the departure mitigation control.

Further, when it is determined that the vehicle M is not present in the predetermined range from the travel lane center (Step S100: No) or when it is determined that the lateral speed of the vehicle M is not within the threshold value (Step S102: No), the control unit 115 determines that the vehicle M is not in the stable state in the travel lane. Therefore, the control unit 115 resets the counter again in order to measure the travel time in the stable state in the travel lane of the vehicle M (Step S116) and transfers the control to the process unit that has called the process of FIG. 4.

The process by the control unit 115 shown in FIG. 4 is sequentially repeated after the departure mitigation control by the first departure control unit 120 or the second departure control unit 130 is started until it is determined that the departure mitigation control is ended in Step S110. When the determination of the notification end of the warning is made by the process shown in FIG. 4, the integrated control unit 140 ends the notification of the warning in the departure mitigation control in the HMI 30.

The “predetermined time” in Step S108 is 2000 ms, and the “predetermined time” in Step S114 is 400 ms; however, the present invention is not limited to these. Each “predetermined time” may be set such that the end condition of the curve departure mitigation control is set to be less likely to be established than the end condition of the straight road departure mitigation control. Therefore, as an example, the end condition “predetermined time” of the curve departure mitigation control in Step S108 is set to be longer than the end condition “predetermined time” of the straight road departure mitigation control in Step S114.

As shown in FIG. 4, the travel determination in the stable state of the vehicle M in the travel lane in Steps S100 and S102 is common in the determination of the end condition of the warning (straight road departure warning) by the straight road departure mitigation control and the warning (curve departure warning) in the curve departure mitigation control. Although the curve departure warning is a control that follows the control of the straight road departure warning, in order to ensure safety, the operation timing of the curve departure warning may be earlier than that of the straight road departure warning. FIG. 6 is a view showing the case where the vehicle M enters a curve on an in-side relative to the curve as indicated by reference numeral P61. In the curve departure warning in the case of FIG. 6, when the vehicle M moves straight from a position indicated by the reference numeral P61 to a position indicated by reference numeral P62, a time when the vehicle M is located near the lane center may occur. If the end conditions of the straight road departure warning and the curve departure warning are the same as each other or substantially the same as each other, a warning process may end by satisfying the end condition of the straight road departure warning. In this case, the curve departure mitigation control does not function sufficiently, and there is a risk that the vehicle M departs from the travel lane in the curve as indicated by reference numeral P63. Therefore, in the process shown in FIG. 4, the elapsed time as the end condition of the curve departure warning is set to be longer such that the end condition of the curve departure warning is less likely to be established than the end condition of the straight road departure warning.

### Another Determination Flow

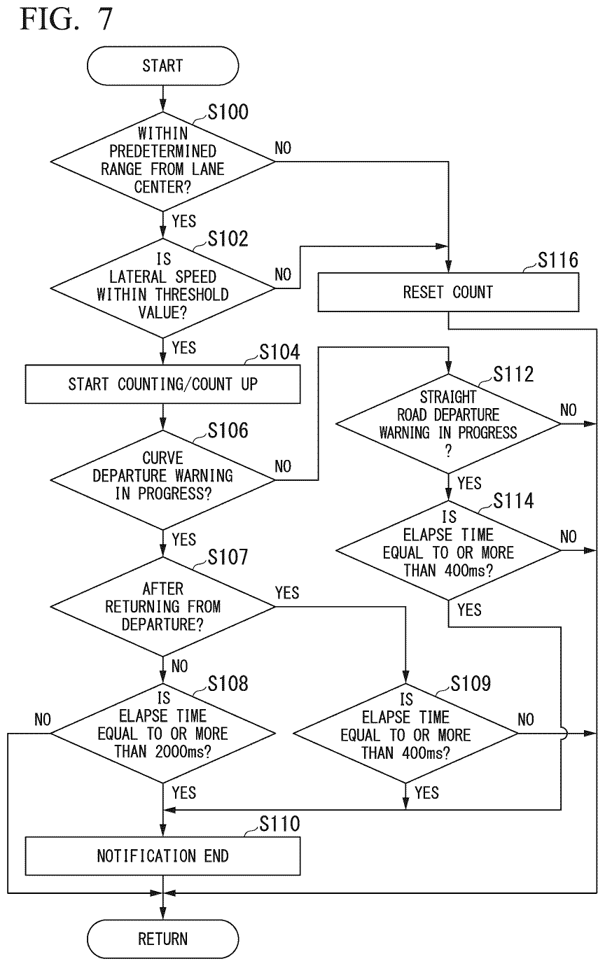

FIG. 7 is a flowchart showing another example of a flow of determination of whether or not it is possible to end the departure mitigation control executed by the control unit 115. In the determination flow of FIG. 4, the elapsed time as the end condition of the curve departure warning is set to be longer such that the end condition of the curve departure warning is less likely to be established than the end condition of the straight road departure warning. On the other hand, in the determination flow of FIG. 7, a condition that the vehicle is in a state after returning from the departure from the travel lane or the like is added to the end condition of the curve departure warning such that the end condition of the curve departure warning is less likely to be established than the end condition of the straight road departure warning. In comparison between the determination flows of FIG. 4 and FIG. 7, there is no difference except that FIG. 7 includes Steps S107 and S109 that are newly added to the determination flow of FIG. 4. Therefore, only the processes relating to Steps S107 and S109 of FIG. 7 are described below.

When it is determined that the curve departure warning is in progress (Step S106: Yes), the control unit 115 determines, based on information from the recognition unit 110, whether the vehicle M is in a state after returning from the departure from the travel lane of the vehicle M during the warning in the departure mitigation control (Step S107). Here, the “departure from the travel lane of the vehicle M” includes a state in which “the vehicle M was traveling on a departure side of the travel lane”, a state in which “the vehicle M was in a state just before the departure”, and the like in addition to the case in which “the vehicle M has departed from the travel lane”. The recognition unit 110 performs the determination of the “departure from the travel lane of the vehicle M” by a position relationship between the vehicle M and a travel road boundary (road boundary) including a road lane line, a road shoulder, a curb, a median strip, a guardrail, and the like that are recognized. The departure from the travel lane in the curve means a departure by a centrifugal force in the traveling in the curve. That is, the departure from the travel lane in the curve means a departure to the right side of the travel lane in a left curve with respect to the traveling direction of the vehicle M and a departure to the left side of the travel lane in a right curve. The control unit 115 determines whether the vehicle M is in a state after returning from the departure from the travel lane of the vehicle M during the warning on the basis of information of the “departure from the travel lane of the vehicle M” of the recognition unit.

When it is determined that the vehicle M is in a state after returning from the departure from the travel lane of the vehicle M during the warning (Step S107: Yes), the control unit 115 determines whether an elapsed time in which the vehicle M is traveling in the stable state in the travel lane becomes equal to or more than a first predetermined time by referring to the counter value (Step S108). Here, the “first predetermined time” is, for example, 400 ms.

On the other hand, when it is determined that the vehicle M has not returned from the departure from the travel lane of the vehicle M during the warning (Step S107: No), the control unit 115 determines whether the elapsed time in which the vehicle M is traveling in the stable state in the travel lane becomes equal to or more than a second predetermined time by referring to the counter value (Step S108). Here, the “second predetermined time” is, for example, 2000 ms similarly to the determination routine shown in FIG. 4.

When it is determined that the elapsed time in which the vehicle is traveling in the stable state becomes equal to or more than the first predetermined time (Step S109: Yes), or when it is determined that the elapsed time in which the vehicle is traveling in the stable state becomes equal to or more than the second predetermined time (Step S108: Yes), the control unit 115 determines that a notification process in the departure mitigation control is ended (Step S110).

When it is determined that the elapsed time in which the vehicle is traveling in the stable state does not become equal to or more than the first predetermined time (Step S109: No) or when it is determined that the elapsed time in which the vehicle is traveling in the stable state does not become equal to or more than the second predetermined time (Step S108: No), the control unit 115 transfers the control to the process unit that has called the process of FIG. 7 in order to continue the end determination of the notification process in the departure mitigation control.

As described above, in the determination of the notification end of the warning shown in FIG. 7, an end condition (Step S107) of whether or not the vehicle M being in a state after the departure from the travel lane of the vehicle M during the curve departure warning is added.

On the other hand, in the determination of the notification end of the warning, with respect to the elapsed time of traveling of the vehicle M in the stable state in the travel lane, the determination time during the curve departure warning is set to be the same as the determination time during the straight road departure warning.

The fact that the vehicle M is in a state after departing from the travel lane of the vehicle M during the curve departure warning can be determined that the vehicle M is in a state after escaping, by a driving control of a driver of the vehicle M, from the departure situation of the travel lane due to the curve of the vehicle M. Therefore, the control unit 115 sets the end condition that uses the elapsed time in which the vehicle is traveling in the stable state in Step S109 to be the same as that in Step S114 under a determination that a driving control for avoiding the departure from the travel lane is performed by the driver of the vehicle M. Thereby, the time for the warning notification can be a short time, and the burden of the driver caused by the warning can be reduced.

In the determination flow of FIG. 7, with respect to the elapsed time of traveling of the vehicle M in the stable state in the travel lane as the determination condition of the notification end of the warning, the time during the curve departure warning and the time during the straight road departure warning are set to be the same time (for example, 400 ms), but are not limited to these, and may be set to be substantially the same time which is a short time.

According to the embodiment described above, the driving assistance device 100 performs the first departure mitigation control (control by the first departure control unit 120) when the travel lane from which the self-vehicle is likely to depart is a straight road, performs the second departure mitigation control (control by the second departure control unit 130) when the travel lane from which the self-vehicle is likely to depart is a curve, and performs an end determination of the departure mitigation control by performing a determination by the first end condition which is the end condition of the first departure mitigation control and the second end condition which is the end condition of the second departure mitigation control. In this case, the driving assistance device 100 performs the end determination of the departure mitigation control under a condition in which the second end condition is set to be less likely to be established than the first end condition. Thereby, the road departure mitigation control of the road departure, in particular, the curve departure mitigation control can be appropriately ended.

The embodiment described above can be expressed as follows.

A vehicle control device includes: a storage device storing a program; and a hardware processor and is configured to: by the hardware processor executing a program stored in the storage device, recognize a travel lane of a self-vehicle; perform, when it is detected that the self-vehicle is likely to depart from the travel lane, a first departure mitigation control when the travel lane from which the self-vehicle is likely to depart is a straight road; perform a second departure mitigation control when the travel lane from which the self-vehicle is likely to depart is a curve; determine whether or not it is possible to end the departure mitigation control by a first end condition which is an end condition of the first departure mitigation control and a second end condition which is an end condition of the second departure mitigation control; and set the second end condition to be less likely to be established than the first end condition.

Although the embodiment of the present invention has been described, the present invention is not limited to the embodiment described above, and various modifications and substitutions can be made without departing from the scope of the present invention.

What is claimed is:

1. A vehicle control device comprising:
a recognition unit that recognizes a travel lane of a self-vehicle; and
a control unit that performs a departure mitigation control of the self-vehicle when the recognition unit detects that the self-vehicle is likely to depart from the travel lane and determines whether or not it is possible to end the departure mitigation control,
wherein the control unit
performs a first departure mitigation control when the travel lane from which the self-vehicle is likely to depart is a straight road,
performs a second departure mitigation control when the travel lane from which the self-vehicle is likely to depart is a curve,
performs a determination by a first end condition which is an end condition of the first departure mitigation control and a second end condition which is an end condition of the second departure mitigation control, and
sets the second end condition to be less likely to be established than the first end condition.

2. The vehicle control device according to claim 1,
wherein the end conditions of the first departure mitigation control and the second departure mitigation control are an elapsed time in which the self-vehicle becomes a stable state in a travel lane, and
the second end condition is set to be longer than the first end condition.

3. The vehicle control device according to claim 2,
wherein the stable state is a state in which the self-vehicle is present within a predetermined range from a travel lane center.

4. The vehicle control device according to claim 2,
wherein the stable state is a state in which a lateral speed of the self-vehicle is within a threshold value.

5. The vehicle control device according to claim 2,
wherein the stable state is a state in which the self-vehicle is present within a predetermined range from a travel lane center and is a state in which a lateral speed of the self-vehicle is within a threshold value.

6. A vehicle control method comprising:
by way of a computer,
recognizing a travel lane of a self-vehicle;
performing, when it is detected that the self-vehicle is likely to depart from the travel lane, a first departure mitigation control when the travel lane from which the self-vehicle is likely to depart is a straight road;
performing a second departure mitigation control when the travel lane from which the self-vehicle is likely to depart is a curve;
determining whether or not it is possible to end the departure mitigation control by a first end condition which is an end condition of the first departure mitigation control and a second end condition which is an end condition of the second departure mitigation control; and
setting the second end condition to be less likely to be established than the first end condition.

7. A computer-readable non-transitory storage medium storing a program that causes a computer to:
recognize a travel lane of a self-vehicle;
perform, when it is detected that the self-vehicle is likely to depart from the travel lane, a first departure mitigation control when the travel lane from which the self-vehicle is likely to depart is a straight road;
perform a second departure mitigation control when the travel lane from which the self-vehicle is likely to depart is a curve;
determine whether or not it is possible to end the departure mitigation control by a first end condition which is an end condition of the first departure mitigation control and a second end condition which is an end condition of the second departure mitigation control; and
set the second end condition to be less likely to be established than the first end condition.
